(19) United States
(12) Patent Application Publication
(10) Pub. No.: US 2021/0304631 A1
(43) Pub. Date: Sep. 30, 2021

(54) Transformative Learning Method

(71) Applicant: Crossing Borders Education Inc., Shutesbury, MA (US)

(72) Inventor: Arnd Wächter, Bo'ness (GB)

(21) Appl. No.: 16/833,507

(22) Filed: Mar. 27, 2020

(51) Int. Cl. G09B 5/12; G09B 5/06; G09B 19/00

(52) U.S. Cl. CPC G09B 5/12; G09B 19/00; G09B 5/065

(57) ABSTRACT

A computer-aided interactive learning method of teaching a subject to students divides an assembly of students into a plurality of peer groups, wherein each peer group comprises diverse students; has the students in each peer group engage with each other via an electronic communication system; provides the students with an instruction material about a concept associated with the subject; has the students in each peer group engage with each other via the computer communication program regarding the concept to formulate an insight; and has the students share the insights from each peer group with other students in the assembly. The educational process of the present invention enhances collaborative learning using elements such as diversity interactions, peer group dynamics, interdisciplinary work, the art of dialogue, and the creative arts. A clear improvement in retention of material by using this method has been observed.

### FIELD OF THE INVENTION

The present invention relates to the field of transformative learning, collaborative learning, social learning, experiential learning, online learning, and interactive learning.

### BACKGROUND

We are living at a time of global crisis on numerous issues such as climate crisis or, security threats (e.g., global health, international conflicts, nuclear) that put an imperative on educating youth towards living in a fast-changing, unpredictable, technically interconnected (but personally disconnected) world. Numerous researches point out that our current education systems are not prepared to face the challenges of the 21st century.

The current education system was developed during the industrial revolution. Before the industrial revolution, the ruling class was quite content with having uneducated masses doing physical labor in the fields and crafts. During the industrial revolution, factory owners needed masses to be able to move into urban centers, read instructions and understand the rules and processes of their industry.

At a time of global crisis, the challenge is not how to get information to students (through technology all info of the world is at their fingertips) but to learn the skills to understand what information is important for them, how to make sense of it, how to prepare for an unpredictable future. Education is currently forced to change and needs to focus on students understanding of how to process complexities, how to communicate, how to collaborate, how to develop self-awareness, how to grow emotional intelligence, how to become themselves.

To address these problems, the use of online tools is seen by many educators on one side as a very helpful learning resource, but on the other side as lacking many of the interpersonal aspects of learning. There are significant challenges for online education to make learning interactive, relational, personal, and effective. For example, there are millions of students signed up to Massive Open Online Courses (MOOCS), but the completion rate is well underneath 10% (one study showed a completion rate of 3.13%). Many experts are pointing out that online learning is missing key parts that make us as humans learn (e.g., relationship, human interactions, emotional experiences, positive peer group pressure such as motivation or feedback, etc.).

A Method and system for providing collaborative learning is disclosed in U.S. Pat. No. 10,403,163. That disclosure relates to methods and systems for providing collaborative learning. In one embodiment, a method includes presenting a first task to a plurality of users on a shared display and receiving inputs via respective input devices for collectively solving the task. The received inputs are analyzed to determine whether the task is correctly performed and to infer one or more probabilistic conclusions about a level of comprehension associated with the first task. An output is presented based upon the probabilistic conclusions about the level of comprehension.

Personalized tutoring streams in a modular learning system is disclosed in International Publication No. WO2013/040110. An apparatus and method were disclosed for generating a personalized tutoring stream in a modular learning system. Learning applications are stored in the modular learning system, each associated with at least one application service. The modular learning system receives a performance request specifying one or more learning applications. After determining an availability of application services associated with the one or more specified learning applications, the modular learning system adds the specified learning applications to a tutoring stream associated with the tutoring user.

Systems, methods and computer program products for collaborative learning is disclosed in U.S. Patent Application Publication No. 2004/191748. A collaborative learning system, method and computer program product permits live, real-time interaction between the audience and a presenter in a controlled learning environment. The collaborative learning system, method, and computer program product provides a learning process that facilitates the transfer of expertise and knowledge using “push” technology. The system includes a presenter subsystem, a backbone subsystem, and an audience subsystem. The process includes pre-event, event and post-event stages. During the pre-event stage, content is created and optimized, and the producer “coaches” the presenter. During the event stage, the presenter and the producer, using the presenter subsystem, push the event material to the audience located remotely at the audience subsystem via the backbone subsystem. The event materials may comprise slides, streaming audio/video and interactive answers to questions and responses to audience feedback. During the post-event stage, follow-up materials are prepared and presented to the audience, case studies are analyzed and the results are presented to the audience, and the event and related documents are “chunked” and archived for later retrieval on demand via a microsite.

Collaborative robotic instruction: A graph teaching experience is disclosed in R. Mitnik et al., Comp. & Ed. 2009, vol. 53, iss. 2, pp. 330-342. Graphing is a key skill in the study of Physics. Drawing and interpreting graphs play a key role in the understanding of science, while the lack of these has proved to be a handicap and a limiting factor in the learning of scientific concepts. It has been observed that despite the amount of previous graph-working experience, students of all ages experience a series of difficulties when trying to comprehend graphs or when trying to relate them with physical concepts such as position, velocity and acceleration. Several computational tools have risen to improve the students' understanding of kinematical graphs; however, these approaches fail to develop graph construction skills. On the other hand, Robots have opened new opportunities in learning. Nevertheless, most of their educational applications focus on Robotics related subjects, such as robot programming, robot construction, and artificial intelligence. This paper describes a robotic activity based on face-to-face computer supported collaborative learning. By means of a set of handhelds and a robot wirelessly interconnected, the aim of the activity is to develop graph construction and graph interpretation skills while also reinforcing kinematics concepts. Results show that students using the robotic activity achieve a significant increase in their graph interpreting skills. Moreover, when compared with a similar computer-simulated activity, it proved to be almost twice as effective. Finally, the robotic application proved to be a highly motivating activity for the students, fostering collaboration among them.

Understanding the relationship between global and diversity learning practice types, critical types, critical thinking and awareness of self and others in college students is disclosed by J. L. Wiley, Ph.D. Thesis, Univ. Missouri-Columbia, 2018. The ability to think critically and complexly amid novel experiences that require self- and other-awareness is something that leaders in an array of social institutions seek to develop in their communities. Global and Diversity Learning (GDL) practices, one category of high impact practices, aim to increase students' awareness of self and others and imbue critical thinking skills that will help students see how their own background and experiences interact with those of peers. That study aimed to understand the relationship of four GDL practices (education abroad, multicultural programming, intercultural living-learning communities, and global studies coursework) to desired learning outcomes. Through completing ANCOVAs and multiple regression analyses on an existing dataset of GDL participants, this study demonstrates the influence of gender, socio-economic status, and citizenship within GDL practice types. The study findings also reveal significant differences between group members' other awareness and critical thinking capacity. Understanding how different GDL practice types affect capacity development will allow university leadership to direct collaboration between departments and align programming, to allocate resources more effectively, and communicate potential outcomes based on empirical data.

Transformative learning theory, a neurobiological perspective of the role of emotions and unconscious ways of knowing is reviewed by E. W. Taylor in Int'l J. Lifelong Ed., 2001, vol. 20, iss. 3, pp 218 to 236.

The evolution of John Mezirow's Transformative Learning Theory is discussed by A. Kitchenham in J. Transformative Ed. 2008, vol. 6, iss. 2, pp 104 to 123.

Transformative learning in adulthood is disclosed by S. Imel in ERIC Digest No. 200. (ED423426, 1998). Jack Mezirow's theory of transformative learning has evolved into a description of how learners learn by integrating new knowledge with their existing knowledge, beliefs, and experiences. Centrality of experience, critical reflection, and rational discourse are three common themes in Mezirow's theory, which is based on psychoanalytic theory and critical social theory. Numerous critical responses to Mezirow's theory of transformative learning have emerged over the years. Robert Boyd, for example, has developed a theory of transformative education based on analytical psychology. Whereas Mezirow's view of transformative learning emphasizes critical reflection and rational discourse, Boyd's emphasizes intuition and emotion. It has been suggested that no single mode of transformative learning exists and that differences in learning contexts, learners, and teachers all affect the experiences of transformative learning. Whether transformative learning is approached as a consciously rational process or through a more intuitive, imaginative process, practitioners seeking to foster a learning environment conducive to transformative learning must consider the following factors: role of the teacher, role of the learner, and role of the rational and affective. Although transformative learning may not always be a goal of adult education, all adult educators should at least strive to understand it.

Creating learner-centered schoolplaces/workplaces for a new culture of students at work is disclosed by B. Pearlman in Ed. Technol. September-October 2009, pp 14 to 19.

### SUMMARY OF THE INVENTION

The present invention is directed to a computer-aided interactive learning method of teaching a subject to students comprising the steps of: dividing an assembly of students into a plurality of peer groups; having the students in each peer group engage with each other via an electronic communication system; providing the students with an instruction material about a concept associated with the subject; having the students in each peer group engage with each other via the computer communication program regarding the concept to formulate an insight; and having the students share the insights from each peer group with other students in the assembly.

The educational process of the present invention enhances collaborative learning using elements such as diversity interactions, peer group dynamics, interdisciplinary work, the art of dialogue, and the creative arts.

Under one embodiment, the present invention is a complex system composed of many components that interact with each other. Characteristics of such a system include emergence, nonlinearity, adaptation, and feedback loops.

The present invention addresses the challenge of bringing effective trust building and relationship building in a scalable way into education processes. The learning process offers here a solution, that tackles complex problems in practical steps.

The present invention is an example of the “Crossing Borders Process”. The phrase “Crossing Borders Process” also incorporates any patentable or nonpatentable improvements to the present invention.

Under one embodiment, the method of the present invention supports a classroom, a school, a set of school, university departments, or universities, to create online classrooms.

The present invention has been shown to be very effective on a pilot scale. The retention rate of the subject learned increased dramatically from about 40% for traditional learning, to about 95% for learning according to the present invention.

Broadly speaking, interactive learning is any learning which encourages students to interact with each other and with the subject matter. Rather than sitting at their desks passively absorbing the material, with the interactive approach, students are part of the lesson. Interactive education involves a variety of techniques that range from lessons that require conversational skills to extensive project-based learning units.

Under one embodiment, the present invention is directed to collaborative learning. Collaborative learning is an education process, in which a plurality of students learn, or attempt to learn, a subject together.

Under one embodiment, the present invention is directed to transformative learning. Transformative learning refers to those learning experiences that cause a shift in an individual's perspective and worldviews. Transformative learning is based on the idea that learning is the process of making a new or revised interpretation of the meaning of an experience.

Under one embodiment, the present invention is directed to social learning. Broadly, the learning occurs with the help of the interaction with other people.

Under one embodiment, the present invention is directed to experiential learning. Broadly, the learning occurs by doing or by through practice. Experiential learning is a process through which students develop knowledge, skills, and values by doing and through practice outside a traditional academic setting.

The present invention is particularly well suited to teaching about concepts that are open-ended, or for subjective concepts that are shaped by personal experiences and biases.

The subject that may be taught by the present method can be any academic, social, cultural, technical, or business subject, as long as there is a subjective element to this subject, and where students can express differing viewpoints.

The present invention is directed to a computer-aided interactive learning method of teaching a subject to an assembly of students comprising a step which entails dividing an assembly of students into a plurality of peer groups, wherein each peer group comprises diverse students.

Upon dividing the students, the students in the peer groups are provided with strategic support so they commit to each other to establish their peer group as a ‘Community of Practice’ for the learning process.

The term “student” means any person who is able to learn. The present invention is suitable for a student of any age, experience, or background. The term “student” is not limited to individuals enrolled in a school (e.g., primary, secondary, university, and like), but encompasses any individual who is able to benefit from expanding their expertise, managing their biases, learning about the subject taught.

The method of the present invention is organized by one or more organizers. The organizers assemble the students, divide the students into peer groups based on diversity, assure that all students have access to the computer communication program so that each can communicate with other students in their peer group, provide the students with the instruction materials, assure that the students communicate with each other regarding the subject and that the students share insights from the peer groups with the assembly.

Under one embodiment, the method of the present invention is suitable for people who have a similar background. Under an alternative embodiment, the students within at least one of the peer groups are diverse.

The phrase “diverse students” means that the students are of sufficiently different background, social class, upbringing, education, and other aspects, that there is a good chance that at least two of the students in each peer group will have different views, attitudes and biases on the subject matter presented.

The present invention is directed to a computer-aided interactive learning method of teaching a subject to students comprising the step of having the students in each peer group engage with each other via a computer communication program.

The purpose of this step prior to the introduction of the instruction material is to let the students, who may not know the other students in their peer group, is to introduce themselves to each other, and get comfortable with each other's opinions. This step is designed to create build trust between diverse students. An omission of this step may result in the disconnection of the students from the learning process and potential stereotyping or discrimination.

The present invention is directed to a computer-aided interactive learning method of teaching a subject to students comprising the step of providing the students with an instruction material about the subject.

The instruction material is prepared by experts in the subject, which may be leveraged by the students to advance their interactive learning. The instruction material is any educational material that presents a concept that is associated with the subject.

The instruction material is any educational material that is presented to the student as to further the understanding of the subject. Examples of the instructional material include an image, a plurality of images, a film, a video, an audio, a text document, a live presentation, or any combination thereof.

Under one embodiment, the instruction material is a video. The video may be comprised of one or more video segments. There are several types of video segments, some of which may be presented in the video.

One type of a video segment is a video prompt. A video prompt is a short video that narrates, describes or illustrates a concept associated with the subject. An example of a video prompt is a cognitive prompt that triggers a cognitive response. An alternative example of a video prompt is a personal prompt modeling self-awareness that triggers self-awareness and emotional intelligence. The prompt may be a presentation by a presenter similar in characteristics similar to those of students, who present a concept as it related to them.

A second type of a video segment is a video segment showing exemplary discussion by a model peer group. The model peer group may be a real peer group from earlier sessions on the same subject, or the model peer group may be a peer group portrayed by actors or participants of previous peer groups.

The present invention is directed to a computer-aided interactive learning method of teaching a subject to students comprising the step of having the students in each peer group engage with each other via the computer communication program regarding the concept to formulate an insight.

The insight is formulated based on the presentation of the instruction material, and a discussion thereof over the computer communication program.

The present invention is directed to a computer-aided interactive learning method of teaching a subject to students comprising the step of having the students share the insights from each peer group with other students in the assembly. These insights may be shared in person, or they may be shared by the electronic communication system.

Under one embodiment, the insights from each peer group are shared on social media with a wider community. This may be shared or posted by the student representative from each peer group, or it may be collected and posted in a batch by the organizer.

The invention of the present application is defined by at least twelve aspects.

In the first aspect, the invention relates to a computer-aided interactive learning method of teaching a subject to students comprising the steps of dividing an assembly of students into a plurality of peer groups; having the students in each peer group engage with each other via an electronic communication system; providing the students with an instruction material about a concept associated with the subject; having the students in each peer group engage with each other via the computer communication program regarding the concept to formulate an insight; and having the students share the insights from each peer group with other students in the assembly.

In the second aspect, the invention relates to a computer-aided interactive learning method of teaching a subject to students comprising the steps of dividing an assembly of students into a plurality of peer groups, wherein at least one of the peer groups comprises students that are diverse from each other; having the students in each peer group engage with each other via an electronic communication system; providing the students with an instruction material about a concept associated with the subject; having the students in each peer group engage with each other via the computer communication program regarding the concept to formulate an insight; and having the students share the insights from each peer group with other students in the assembly.

In the third aspect, the invention relates to a computer-aided interactive learning method of teaching a subject to students comprising the steps of dividing an assembly of students into a plurality of peer groups; having the students in each peer group engage with each other via an electronic communication system, where the students in each peer group engage with each other via an electronic communication system in an open, personal or empathic dialogue; providing the students with an instruction material about a concept associated with the subject; having the students in each peer group engage with each other via the computer communication program regarding the concept to formulate an insight; and having the students share the insights from each peer group with other students in the assembly.

In the fourth aspect, the invention relates to a computer-aided interactive learning method of teaching a subject to students comprising the steps of (a) dividing an assembly of students into a plurality of peer groups; (b) having the students in each peer group engage with each other via an electronic communication system; (c) providing the students with an instruction material about a concept associated with the subject; (d) having the students in each peer group engage with each other via the computer communication program regarding the concept to formulate an insight; and (e) having the students share the insights from each peer group with other students in the assembly, wherein steps (c) and (d) are repeated, wherein a different concept associated with the subject.

In the fifth aspect, the invention relates to a computer-aided interactive learning method of teaching a subject to students comprising the steps of dividing an assembly of students into a plurality of peer groups; having the students in each peer group engage with each other via an electronic communication system; providing the students with an instruction material about a concept associated with the subject, wherein the instruction material is selected from the group consisting of an image, a plurality of images, a film, an audio, a video, a text document, a live presentation, and a combination thereof; having the students in each peer group engage with each other via the computer communication program regarding the concept to formulate an insight; and having the students share the insights from each peer group with other students in the assembly.

In the sixth aspect, the invention relates to a computer-aided interactive learning method of teaching a subject to students comprising the steps of dividing an assembly of students into a plurality of peer groups; having the students in each peer group engage with each other via an electronic communication system; providing the students with an instruction material about a concept associated with the subject, wherein the instructional material is a video, wherein the video comprises a video segment showing exemplary discussion by a model peer group; having the students in each peer group engage with each other via the computer communication program regarding the concept to formulate an insight; and having the students share the insights from each peer group with other students in the assembly.

In the seventh aspect, the invention relates to a computer-aided interactive learning method of teaching a subject to students comprising the steps of dividing an assembly of students into a plurality of peer groups; having the students in each peer group engage with each other via an electronic communication system; providing the students with an instruction material about a concept associated with the subject; having the students in each peer group engage with each other via the computer communication program regarding the concept to formulate an insight; and having the students share the insights from each peer group with other students in the assembly, wherein at least one the students in at least one peer group has a personal experience with the concept.

In the eighth aspect, the invention relates to a computer-aided interactive learning method of teaching a subject to students comprising the steps of dividing an assembly of students into a plurality of peer groups; having the students in each peer group engage with each other via an electronic communication system; providing the students with an instruction material about a concept associated with the subject; having the students in each peer group engage with each other via the computer communication program regarding the concept to formulate an insight; and having the students share the insights from each peer group with other students in the assembly, wherein at least two students in at least one peer group have personal experiences with the concept.

In the ninth aspect, the invention relates to a computer-aided interactive learning method of teaching a subject to students comprising the steps of dividing an assembly of students into a plurality of peer groups; having the students in each peer group engage with each other via an electronic communication system; providing the students with an instruction material about a concept associated with the subject; having the students in each peer group engage with each other via the computer communication program regarding the concept to formulate an insight; and having the students share the insights from each peer group with other students in the assembly, wherein at least two students in at least one peer group have personal experiences with the concept, wherein each of the at least two students has a different personal experiences with the concept.

In the tenth aspect, the invention relates to a computer-aided interactive learning method of teaching a subject to students comprising the steps of dividing an assembly of students into a plurality of peer groups, wherein the assembly of students comprises between 4 and about 2000 students; having the students in each peer group engage with each other via an electronic communication system; providing the students with an instruction material about a concept associated with the subject; having the students in each peer group engage with each other via the computer communication program regarding the concept to formulate an insight; and having the students share the insights from each peer group with other students in the assembly.

In the eleventh aspect, the invention relates to a computer-aided interactive learning method of teaching a subject to students comprising the steps of dividing an assembly of students into a plurality of peer groups; having the students in each peer group engage with each other via an electronic communication system; providing the students with an instruction material about a concept associated with the subject; having the students in each peer group engage with each other via the computer communication program regarding the concept to formulate an insight; and having the students share the insights from each peer group with other students in the assembly, and wherein the insights from each peer group are shared on social media with a wider community.

### DETAILED DESCRIPTION OF THE INVENTION

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other apparatuses and methods. Before explaining the disclosed embodiments of the present invention in detail, it is to be understood that the invention is not limited in its application to the details of any particular embodiment shown. The terminology used herein is for the purpose of description and not of limitation.

As used herein and in the appended claims, the singular forms “a”, “an”, and “the” include plural references unless the context dictates otherwise. The terms “a” (or “an”), “one or more” and “at least one” may be used interchangeably herein. The terms “comprising”, “including”, and “having” may be used interchangeably. The term “include” should be interpreted as “include, but are not limited to”. The term “including” should be interpreted as “including, but are not limited to”.

The abbreviations and symbols as used herein, unless indicated otherwise, take their ordinary meaning. The term “about” when referring to a number means any number within a range of 10% of the number. For example, the phrase “about 2000 students” refers to a number between and including 1800 and 2200.

As used throughout, ranges are used as shorthand for describing each and every value that is within the range. Any value within the range can be selected as the terminus of the range.

As used throughout, for readability purposes, the third person plural pronouns also refer to third person singular pronouns. For example, in English, the pronouns “they”, “them”, “theirs”, and any other declensions of the third person plural pronoun, also refers to the similarly declined third person singular pronouns, such as “he”, “him”, “his”, “she”, “her”, “hers”, “he or she”, “him or her”, “his or hers”, “ye”, “ver”, “vis”, “xe”, “xem”, “xyr”, “ze”, “hir”, “hirs”, and like.

Any member in a list of species that are used to exemplify or define a genus may be mutually different from, or overlapping with, or a subset of, or equivalent to, or nearly the same as, or identical to, any other member of the list of species. Further, unless explicitly stated (such as when reciting a Markush group), the list of species that define or exemplify the genus is open, and it is given that other species may exist that define or exemplify the genus just as well as, or better than, any other species listed.

All references cited herein are hereby incorporated by reference in their entireties. In the event of a conflict in a definition in the present disclosure and that of a cited reference, the present disclosure controls.

The present invention is directed to a computer-aided interactive learning method of teaching a subject to students comprising the steps of: dividing an assembly of students into a plurality of peer groups; having the students in each peer group engage with each other via an electronic communication system; providing the students with an instruction material about a concept associated with the subject; having the students in each peer group engage with each other via the computer communication program regarding the concept to formulate an insight; and having the students share the insights from each peer group with other students in the assembly.

The educational process of the present invention enhances collaborative learning using elements such as diversity interactions, peer group dynamics, interdisciplinary work, the art of dialogue, and the creative arts.

Creative arts means a method of conveying information between individuals beyond a simplistic conveyance of information. Examples of creative arts include graphic design, filmmaking, storytelling, and photography.

Under one embodiment, the present invention is a complex system composed of many components that interact with each other. Characteristics of such a system include emergence, nonlinearity, adaptation, and feedback loops.

One of the advantages of the present invention is that it is particularly suitable for students of diverse backgrounds.

The present invention is useful to address the needs of education during and after an epidemic or a pandemic crisis. Examples of past pandemic crises include typhoid fever, influenza, Antonine plague, Plague of Cyprian, Plague of Justinian, Black Death, Third Plague, San Francisco Plague, Spanish Flu, HIUV/AIDS, and Coronavirus disease 2019. The present invention utilizes multimedia resources that can support empathic dialogue and personal reflection in the online learning environment—addressing the urgent needs for deep interpersonal connections around topics of emotional well-being in uncertain times.

The present invention is particularly well-suited to address the educational challenges of institutes of higher learning. Universities are increasingly diverse places, especially in our metropolitan cities. On one hand, students are ‘asked’ to appreciate diversity for many reasons (e.g., ethically, socially, economically) and are ‘thrown into’ a diverse setting (many universities have well over 100 nationalities on campus). On the other hand, when reviewing learnings within the field of neuroscience, it is understandable that there is resistance (e.g., our worldviews are formed very early in our lives; our brains are wired for tribalism and group thinking for thousands of generations; implicit biases are unconscious; motivated reasoning is real).

The present invention addresses the challenge of bringing effective trust building and relationship building in a scalable way into education processes. The learning process offers here a solution, that tackles complex problems in practical steps.

The present invention is an example of the “Crossing Borders Process”. The phrase “Crossing Borders Process” also incorporates any patentable or nonpatentable improvements to the present invention.

Under one embodiment, the method of the present invention supports a classroom, a school, a set of school, university departments, or universities, to create online classrooms. For example, the method of the present invention is suitable to for use by the Institute of Education, Department of Education, Ministry of Education, or other governmental or quasi-governmental bodies to develop an online classroom in which teachers produce and then hundreds of classrooms engage with. The method of the present invention is suitable to support regions and schools to collaborate with each other to produce content collaboratively.

The present invention has been shown to be very effective on a pilot scale. The retention rate of the subject learned increased dramatically from about 40% for traditional learning, to about 95% for learning according to the present invention.

The present invention is scalable to reach service school districts. Under one embodiment, the content is created by core teams of educators with different skill sets (e.g., 2 online hosts, 4 curriculum designers, and 2 IT personnel) to produce the material. During a pilot run, the content is improved by getting direct feedback from a selected pilot group of parents and students that go through the classwork before the livestreaming. This feedback revolutionizes education, because such use would be interdisciplinary and intergenerational content creation. The parent provide content feedback from very different disciplines, and students provide feedback of what is engaging for them and what content is not. Under one embodiment, the students also become the ‘Community of Practice’ to identify online videos that are inspirational, or educational, or both, as the students know best what works for them.

The method of the present invention is also useful for the training of teachers or staff, on how to teach online.

The method of the present invention is also suitable in school setting, wherein a teacher interacts with 3 to 5 students around the instructional material, and the entire local classes joins the livestream. This is followed by debriefing activities with their teachers in their small groups on Zoom. Under one embodiment, the streaming is live. Under one embodiment, the streaming is pre-recorded, slightly edited, and then livestreamed by one or two hosting teachers). The students the share insights within their class or network creating a sense of community identity in the process

Broadly speaking, interactive learning is any learning which encourages students to interact with each other and with the subject matter. Rather than sitting at their desks passively absorbing the material, with the interactive approach, students are part of the lesson. Interactive education involves a variety of techniques that range from lessons that require conversational skills to extensive project-based learning units. Interactive learning sharpens critical thinking skills, which are fundamental to the development of analytic reasoning. A student who can explore an open-ended question with imagination and logic is learning how to make decisions, as opposed to just regurgitating memorized information. Also, interactive learning teaches students how to collaborate and work successfully in groups, an indispensable skill as workplaces become more team-based in structure and incorporate team members who will be located in many different locales. Learning to understand the personalities of remote colleagues is a vital skill obtained through interactive learning.

The interactive learning of the present invention incorporates social networking, digital technology, and virtual communication.

Under one embodiment, the present invention is directed to collaborative learning. Collaborative learning is an education process, in which a plurality of students learn, or attempt to learn, a subject together. In collaborative learning, unlike in individual learning, students engaged capitalize on one another's resources and skills. Examples of such engagement include asking one another for information, evaluating one another's ideas, monitoring one another's work, properly dividing certain tasks within the group to promote efficiency, and like.

Collaborative learning of the present invention may be illustrated in that peer groups of students work together to search for understanding, meaning, or solutions or to create an artifact or product of their learning. This method of teaching students redefines the traditional student-teacher relationship in the classroom. Collaborative learning activities can include collaborative writing, group projects, joint problem solving, debates, study teams, and other activities.

Further, collaborative learning of the present invention is based on the model that knowledge can be created within a population of students wherein the students actively interact by sharing experiences and take on asymmetric roles. The students engage in a common task where each individual depends on and is accountable to each other.

Under one embodiment, the student engagement is done via face-to-face conversations or discussions. Under one embodiment, the student engagement is via computer discussions, such as online forums, chat rooms, and like.

Under one embodiment, the efficacy of the collaborative learning processes of the present invention include conversation analysis and statistical discourse analysis.

The term “computer-aided” means that the learning method is, in at least partially, conducted via a computer network. Under one embodiment, the function of the computer network is to allow the individual students to communicate with each other over the computer network.

Under one embodiment, the present invention is directed to transformative learning. Transformative learning refers to those learning experiences that cause a shift in an individual's perspective and worldviews. Transformative learning is based on the idea that learning is the process of making a new or revised interpretation of the meaning of an experience. This process happens when students change their assumptions or expectations. What often follows is a change in the student's frame of reference for interpretation and understanding.

Under one embodiment, the present invention is directed to social learning. Broadly, the learning occurs with the help of the interaction with other people. Social learning refers to the learning process which proposes that new behaviors can be acquired by observing and imitating others. Learning is a cognitive process that takes place in a social context and can occur purely through observation or direct instruction. In addition to the observation of behavior, learning also occurs through the observation of rewards and punishments.

Under one embodiment, the present invention is directed to experiential learning. Broadly, the learning occurs by doing or by through practice. Experiential learning is a process through which students develop knowledge, skills, and values by doing and through practice outside a traditional academic setting. The method of the present invention is a well-planned, supervised, and assessed experiential learning program that stimulates academic and social inquiry by promoting interdisciplinary learning, cultural awareness, leadership, and civic engagement.

Under one embodiment, the experiential learning includes reflection, critical analysis, and synthesis. It provides opportunities for students to take initiative, make decisions, and be accountable for the results. Further, it provides opportunities for students to engage intellectually, creatively, emotionally, and socially. Under one embodiment, the experiential learning may take the form of remote and/or virtual internships within a chosen industrial or technology area. Such internships can be designed by a collaboration of the student's instructor and at least one supervisor at the hosting entity.

Under one embodiment, the present method utilizes the variation of the fishbowl method of conversation. The fishbowl conversation is a form of dialog that can be used when discussing topics within large groups. The advantage of fishbowl is that it allows the entire group to participate in a conversation. Several people can join the discussion. The Fishbowl format is well established in offline events.

The method of the present invention utilizes the fishbowl concept online. With the online fishbowl format, some of the issues of the Fishbowl live events are successfully addressed. For example, online fishbowl provides a safer environment for students who are shy.

The term “subject” as used throughout the description of the present invention means a subject that is conducive to be learned. The subject may be on any complexity. Under one embodiment, the subject is a simple concept. Under one embodiment, the subject is a complicated concept over which much ink has been spilled.

The present invention is particularly well suited to teaching about concepts that are open-ended, or for subjective concepts that are shaped by personal experiences and biases.

The subject that may be taught by the present method can be any academic, social, cultural, technical, or business subject, as long as there is a subjective element to this subject, and where students can express differing viewpoints.

The present invention is directed to a computer-aided interactive learning method of teaching a subject to an assembly of students comprising a step which entails dividing an assembly of students into a plurality of peer groups, wherein each peer group comprises diverse students.

The division process may take the form of a random selection or selections based upon an algorithm utilizing such properties as, for example, the students' academic standing, the students' demographic characteristics, student answers to questionnaires, and like. Under one embodiment, the algorithm seeks to maximize the diversity of students with respect to the subject.

Upon dividing the students, the students in the peer groups are provided with strategic support so they commit to each other to establish their peer group as a ‘Community of Practice’ for the learning process.

The Community of Practice is a peer group of students who share a concern or passion for something they do and learn how to do it better as they interact regularly. The Community of Practice aides learning by leveraging the fact that most students have a natural human desire is to connect and to experience a sense of belonging. The Community of Practice is particularly effective at a time of social disruption.

Under one embodiment, at least some of the students are successful in achieving personal transformation. Instead of limit the view of learning to the idea of receiving new knowledge through a text or expert (which may not result in learning or retaining anything), the Community of Practice adds to knowledge by relying on two forms of learning: social learning (i.e., learning from other people), and experiential learning (i.e., learning by doing).

Under one embodiment, the members of the peer groups that are Communities of Practice, support each other. They support each other to overcome isolation through deep connection, to strengthen communication through empathic dialogue, and to grow life skills through interpersonal encouragement.

As the Community of Practice matures, the students who are its members move from simply sharing knowledge to solving problems. The problem-solving ability of the Community of Practice relies on the collective intelligence of the Community of Practice.

The students get personally motivated within the Community of Practice group. In Community of Practice, the students may be motivated by experiencing positive relationships with other students in the Community of Practice, or by personal growth and self-acceptance, or by an enhanced purpose in life.

The “assembly of students” represents all of the students that are to be taught the subject at one time. The assembly should be sufficiently large that it is possible to split the students into at least two peer groups, wherein each of the peer groups has at least students.

The assembly of students contains at least 4 students, but the maximum number of students is limited only be practical consideration and not by the features of the present invention. Under one embodiment, the assembly of students comprises between 4 and about 2000 students. Under one embodiment, the assembly of students comprises between about 10 and about 2000 students. Under one embodiment, the assembly of students comprises between about 30 and about 2000 students. Under one embodiment, the assembly of students comprises between about 100 and about 2000 students. Under one embodiment, the assembly of students comprises between about 400 and about 2000 students. Under one embodiment, the assembly of students comprises between 4 and about 400 students. Under one embodiment, the assembly of students comprises between about 10 and about 400 students. Under one embodiment, the assembly of students comprises between about 30 and about 400 students. Under one embodiment, the assembly of students comprises between about 100 and about 400 students. Under one embodiment, the assembly of students comprises between 4 and about 100 students. Under one embodiment, the assembly of students comprises between about 10 and about 100 students. Under one embodiment, the assembly of students comprises between about 30 and about 100 students. Under one embodiment, the assembly of students comprises between 4 and about 30 students. Under one embodiment, the assembly of students comprises between about 10 and about 30 students. Under one embodiment, the assembly of students comprises between 4 and about 10 students.

Each of the peer groups must contain at least two students. The peer group may be as small as two students, and as large as 10 students. Under one embodiment, a peer group comprises two students. Under one embodiment, a peer group comprises three students. Under one embodiment, a peer group comprises four students. Under one embodiment, a peer group comprises five students. Under one embodiment, a peer group comprises six students. Under one embodiment, a peer group comprises seven students. Under one embodiment, a peer group comprises eight students. Under one embodiment, a peer group comprises nine students. Under one embodiment, a peer group comprises ten students. Under one embodiment, a peer group comprises more than ten students.

Under one embodiment, the number of students in any peer group should be equal to the number of students in other peer groups. In cases where it is not possible to achieve equal distribution of students across all peer groups, the number of students per any peer group should be the same, one more student, or one less student of any of the other peer groups. For example, in case of an assembly of 41 students, the students may be divided into 19 peer groups of two students each and 1 peer group of three students; or into 10 peer groups of two students each and 7 peer groups of three students; or into 7 peer groups of three students and 5 peer groups of four students; or into 4 peer groups of four students and 5 peer groups of five students; or into 1 peer group of five students and 6 peer groups of six students, and like.

The optimal number of students depending on the subject, and on the characteristic of the students. Typically, if the students have opinions or experience with the subject, the number of students in each peer group may be smaller, such as 2, 3 or 4 students per peer group. If the students are naïve (i.e., have little or no exposure) to the subject, then the number of students per peer group may be larger, such as 4, 5, 6 or more students per peer group.

Experimental data shows that for teaching sociological subjects, the most effective peer group size is four students.

The term “student” means any person who is able to learn. The present invention is suitable for a student of any age, experience, or background. The term “student” is not limited to individuals enrolled in a school (e.g., primary, secondary, university, and like), but encompasses any individual who is able to benefit from expanding their expertise, managing their biases, learning about the subject taught.

Under one embodiment, the present invention is particularly suitable for students who are able to communicate over the computer networks with other similarly situated students.

Under one embodiment, the students who are suitable to take advantage of the method of the present invention are those who students who have some experience with, or some view on, the subject being taught. This is particularly useful for graduate level education or professional school education (such as law school, business school, and like) where the students have significant work experience.

Under one embodiment, the students who are suitable to take advantage of the method of the present invention are those who students who have a different experience with, or a different view of, the subject being taught than those of others in the peer group.

Students may be grade school-aged children, middle school-aged children, high school-aged children, college-age students, workers, professionals, or retirees. Students of the present invention may be students in a school, or people in a profession or social setting.

The method of the present invention is suitable to teach a subject to incoming college students to mitigate potential criminal, personal and societal problems that college students may encounter. Examples of suitable subjects include education on racism, anti-racism, hazing, anti-hazing, sexism, anti-sexism, rape, anti-rape, agism, anti-agism, sexual assault, anti-sexual assault, xenophobia, anti-xenophobia, and like.

The method is also suitable to teach Continuing Education classes (or Further Education class) to professionals who are licensed in certain professions for professional development. Examples of Continuing Education classes include Continuing Legal Education and Continuing Medical Education.

The method is also suitable to teach subject to a group of professionals, tradespeople, businesspeople and like. The subject may be in any field, including compliance, regulatory affairs, law enforcement, safety, compliance with local regulations, compliance with state regulations, compliance with national regulations, compliance with regional regulations, and like.

The method of the present invention is also suitable to resolve business problems. The students in such a case are employees, workers, consultants, professionals, or other experts in various fields. To maximize the effectiveness of the present invention, students in each peer group should be diverse with each other.

The method of the present invention is organized by one or more organizers. Organizers include teachers, mentors, coaches, and like. The organizers assemble the students, divide the students into peer groups based on diversity, assure that all students have access to the computer communication program so that each can communicate with other students in their peer group, provide the students with the instruction materials, assure that the students communicate with each other regarding the subject and that the students share insights from the peer groups with the assembly.

Under one embodiment, the method of the present invention is suitable for people who have a similar background. Under an alternative embodiment, the students within at least one of the peer groups are diverse.

The phrase “diverse students” means that the students are of sufficiently different background, social class, upbringing, education, and other aspects, that there is a good chance that at least two of the students in each peer group will have different views, attitudes and biases on the subject matter presented.

The phrase “diverse student” and the term “diversity” are not absolute, but are associated with the subject taught. If, for example, the subject is the mitigation of sexual harassment, the diversity may be along the lines of gender, or along the lines of experiencing harassment. If, for example, the subject is the improvement of the quality of a manufactured product, then the diversity may be along the lines of job function. Hence, a male engineer and a female engineer may likely be considered diverse in the first example but may likely be considered as non-diverse in the second example. On the other hand, a male engineer and a male pilot plant manager may be not diverse in the first example but they may be diverse in the second example.

A preliminary test may be administered before the division of the assembly of students into peer groups, to ascertain the students' views, experiences, and biases. This preliminary step is useful to provide ensure that each peer group contains people of differing views, experiences, and biases. This is especially useful in cases where there is limited apparent diversity in the student assembly.

Under one embodiment, the students are not aware that there is a diversity within the peer group. The students may have never met with the other persons in the group, thus obviating any personal biases that may be presented if the students were to have met in person.

The present invention is directed to a computer-aided interactive learning method of teaching a subject to students comprising the step of having the students in each peer group engage with each other via a computer communication program.

The phrase “having the students in each peer group engage”, or “have the students in each peer group engage” means that the organizer allows, encourages, or otherwise effectuates the engagement of the students in each peer group. Under one embodiment, the organizer provides the computer communication program or assures that each student has ready access to the computer communication program.

The phrase “an electronic communication system” refers to any electronic communication by students that are at different physical locations. Under one embodiment, the phrase “electronic communication system” refers to “computer communication program”, “computer network”, “social network”, and like.

Typically, each student uses their own communication device (such as a cell phone, tablet, phablet, laptop computer, desktop computer and like) to access the electronic communication system

Examples of the electronic communication system include blogs, Facebook, Twitter, YouTube, Vimeo, Instagram, Snapchat, LinkedIn groups, Zoom, VK, Wattpad, Tumblr, WhatsApp, Messenger, WeChat, QQ, Qzone, TikTok, Sina Weibo, Reddit, Baidu Tieba, Viber, Pinterest, Line, Telegram, Medium, applications related thereto, and other applications similar thereto. Under one embodiment, the electronic communication system is built specifically for use with the present invention.

Under one embodiment, the electronic communication system sends a message, a text, a video, a voice file, a picture, or any other type of communication instantaneously from one student to all of the other members of the peer group.

Under one embodiment, this electronic communication system is able to communicate with the organizer. Such communication may be one way. Such communication may be done without the knowledge of the students.

Under one embodiment, the students in each peer group engage with each other via the electronic communication system in open, personal and self-facilitated ways that suspend cognitive and/or divisive debate, and instead engage in open, personal and empathic dialogue.

The purpose of this step prior to the introduction of the instruction material is to let the students, who may not know the other students in their peer group, is to introduce themselves to each other, and get comfortable with each other's opinions. This step is designed to create build trust between diverse students. An omission of this step may result in the disconnection of the students from the learning process and potential stereotyping or discrimination.

The present invention is directed to a computer-aided interactive learning method of teaching a subject to students comprising the step of providing the students with an instruction material about the subject.

The instruction material is prepared by experts in the subject, which may be leveraged by the students to advance their interactive learning.

The instruction material is any educational material that presents a concept that is associated with the subject. The term “concept”, as used in the phrase “concept associated with the subject” represents at least a portion of the subject is presented to the students.

Under one embodiment, the concept encompasses the entirety of the subject.

Under one alternative embodiment, the concept encompasses a part of the subject. The concept presented in the instructional material may encompass one part of the subject, and additional concepts may be presented by instructional materials in additional repetitions of this step.

The instruction material is any educational material that is presented to the student as to further the understanding of the subject. Examples of the instructional material include an image, a plurality of images, a film, a video, an audio, a text document, a live presentation, or any combination thereof.

In addition to being provided with the instruction material, the students may also be provided with other information. Such other information may include technical assistance, information to help to understand the instructional material, administrative information, logistics, or other information that falls within the definition of instructional material.

Under one embodiment, the instructional material is presented to each student via the electronic communication system used in the previous step. Under one embodiment, the instructional material is presented by a different electronic communication system than used in the previous step. Under one embodiment, the instructional material is presented by other means than via an electronic communication system, such as in-classroom presentation, a live presentation, a printed document, and like.

Under one embodiment, all of the students are provided with identical instruction material.

Under one embodiment, some students are provided with a slightly different or markedly different material than other students. Such a difference in the material may mitigate the differences due to students' diversity, or they many exasperate the differences due to students' diversity. For example, a video demonstrating sexual harassment may be narrated or shown in a way to downplay the severity of sexual harassment or to highlight the severity of sexual harassment, and then the videos are shown to the students of corresponding biases, or alternatively, to the students of non-corresponding biases.

Under one embodiment, the instruction material is a video. The video may be comprised of one or more video segments. There are several types of video segments, some of which may be presented in the video.

One type of a video segment is a video prompt. A video prompt is a short video that narrates, describes or illustrates a concept associated with the subject.

An example of a video prompt is a cognitive prompt that triggers a cognitive response. More specifically, the video prompt shows a news clip from a recent TV report or an online report. The TV report or the online report may show civil unrest, a political demonstration, election results, an example of unjust treatment of a person or a group of people, a natural disaster, a manmade disaster, pandemic, and like.

An alternative example of a video prompt is a personal prompt modeling self-awareness that triggers self-awareness and emotional intelligence. The prompt may be a presentation by a presenter similar in characteristics similar to those of students, who present a concept as it related to them. The presenter may be a person talking about their own experience about the concept, or is may be an actor or actress performing in such a manner. An example of a personal prompt is a video of a woman telling about her experience of not being taken seriously at work and how it made her feel. An alternative example of a personal prompt is a video of a racial minority person describing his experience when stopped by police and how it made him feel.

A second type of a video segment is a video segment showing exemplary discussion by a model peer group. The model peer group may be a real peer group from earlier sessions on the same subject, or the model peer group may be a peer group portrayed by actors or participants of previous peer groups.

The video segment showing exemplary discussion by a model peer group may show the students of the peer group actively listening and thoughtfully contributing to the concept as presented in an earlier video segment.

One advantage of having video segments showing model peer groups is that it makes the students watching the video more acceptable to things presented by a model peer group rather than a teacher, instructor, or another administrator.

Another advantage of video segments showing model peer groups is the that it takes advantage of peer pressure. Peer pressure is the direct influence on people by peers, or the effect on an individual who gets encouraged to follow their peers by changing their attitudes, values or behaviors to conform to those in the peer group, or several members of the peer group. This can result in either a positive or negative effect, or both. Peer pressure can increase or decrease student's own confidence. Peer pressure can affect individuals of all ethnicity, genders and ages, however. Research suggests that not just individuals but also organizations, such as large corporations, are susceptible to peer pressures, such as pressures from other firms in their industry or headquarters city. Peer pressure also links to transformative learning, which shows that we usually only let that new information into our thinking that supports or links to our existing worldview. It is usually a ‘life crisis’ that unsettles the student's worldview that the student opens up to new ways of thinking. Other pathways are new experiences and learning through people we trust and identify with like peers.

One aspect of the invention is the use of the exemplary discussion by a model peer group to teach the students. This technique does not to use experts as teachers, but to create a structured process in which peers become teachers to each other by personally modeling how to respond to ‘core content’ with self-awareness. Under one embodiment, the learning happens through ‘social learning’ through other people and ‘experimental learning’ by doing/practicing.

The present invention is directed to a computer-aided interactive learning method of teaching a subject to students comprising the step of having the students in each peer group engage with each other via the computer communication program regarding the concept to formulate an insight.

The phrase “having the students in each peer group engage”, or “have the students in each peer group engage” means that the organizer allows, encourages, or otherwise effectuates the engagement of the students in each peer group.

The insight is formulated based on the presentation of the instruction material, and a discussion thereof over the computer communication program.

Under one embodiment of the present invention, at least one student in a peer group has a personal experience with the concept. This is helpful to formulate the insight because the student with personal experience will be able to lead the discussion on the subject to obtain a reasonable insight.

Under one embodiment of the present invention, at least two students in a peer group have a personal experience with the concept. This helps formulate the insight because the students will be able to quickly focus on the differences in the views and opinions of the fellow peer group members to obtain a reasonable insight.

The present invention is directed to a computer-aided interactive learning method of teaching a subject to students comprising the step of having the students share the insights from each peer group with other students in the assembly.

The phrase “having the students share the insights”, or “have the students share the insights” means that the organizer allows, encourages, or otherwise effectuates the sharing of the insight of the students in each peer group.

These insights may be shared in person, or they may be shared by the electronic communication system.

Typically, one student is chosen to present the insight gained by the peer group to the assembly.

Under one embodiment, the insights from each peer group are shared on social media with a wider community. This may be shared or posted by the student representative from each peer group, or it may be collected and posted in a batch by the organizer.

Based on the similarities and differences of the insights from each peer group, the students are able to learn about the subject more than if they were to be told of the subject from a teacher. The student involvement in the collaborative learning and interactive learning yields better acceptability of the subject because each student experiences a buy-in into the arrived at conclusion.

### EXPERIMENTAL

A collaborative project of several universities with Crossing Borders Education, Inc. (Shutesbury, Mass., USA) focused on creative ways to encourage, strengthen and nurture authentic student voices in the learning environment, which are instrumental in order to enhance emotional intelligence and intercultural awareness.

Observations by the investigators showed that this project helped to address several key challenges of online interactions by supporting students to overcome isolation and address fears by connecting deeply.

In collecting video data from students through selected courses, it was noted that large group online interactions alone do not produce deep learning.

Follow-up studies to address this lack of deep understanding observed in large online groups have designed and tested.

The final successful design has shown that learning occurs in the settings recited by the claims.

It has been observed that the process of providing video segments showing exemplary discussion by a model peer group, using intentionally selected small groups for intragroup dialog, and the use of peer video to model intercultural and interpersonal skills increased the depth of learning that the more traditional approaches to virtual dialogues did not.

Further, it has been observed that the process of providing video segments showing exemplary discussion by a model peer group, using intentionally selected small groups for intragroup dialog, and the use of peer video to model intercultural and interpersonal skills increased the depth of learning that the more traditional approaches to intercultural learning did not.

Still further, it has been observed that the process of providing video segments showing exemplary discussion by a model peer group, using intentionally selected small groups for intragroup dialog, and the use of peer video to model intercultural and interpersonal skills increased the transformation of worldview that the more traditional approaches to virtual dialogues did not.

Yet further, it has been observed that the process of providing video segments showing exemplary discussion by a model peer group, using intentionally selected small groups for intragroup dialog, and the use of peer video to model intercultural and interpersonal skills increased the transformation of worldview that the more traditional approaches to intercultural learning did not.

Studies further observed how difficult it is for students to produce authentic video content in an academic class setting as it would require to risk vulnerability, which would require sufficient time for trust-building and shared experiences. It has been ascertained that students are naturally shy or reluctant to disclose their deepest feelings in video formats in an academic setting.

What is claimed is:

1. A computer-aided interactive learning method of teaching a subject to students comprising the steps of:
(a) dividing an assembly of students into a plurality of peer groups;
(b) having the students in each peer group engage with each other via an electronic communication system;
(c) providing the students with an instruction material about a concept associated with the subject;
(d) having the students in each peer group engage with each other via the computer communication program regarding the concept to formulate an insight; and
(e) having the students share the insights from each peer group with other students in the assembly.

2. The method of claim 1 wherein at least one of the peer groups comprises students that are diverse from each other.

3. The method of claim 1, where in step (b), the students in each peer group engage with each other via an electronic communication system in an open, personal or empathic dialogue.

4. The method of claim 1, wherein steps (c) and (d) are repeated, wherein a different concept associated with the subject.

5. The method of claim 1, wherein the instruction material is selected from the group consisting of an image, a plurality of images, a film, an audio, a video, a text document, a live presentation, and a combination thereof.

6. The method of claim 5, wherein the instructional material is a video, wherein the video comprises a video segment showing exemplary discussion by a model peer group.

7. The method of claim 1, wherein at least one the students in at least one peer group has a personal experience with the concept.

8. The method of claim 1, wherein at least two students in at least one peer group have personal experiences with the concept.

9. The method of claim 8, wherein each of the at least two students has a different personal experiences with the concept.

10. The method of claim 1, wherein the assembly of students comprises between 4 and about 2000 students.

11. The method of claim 1, wherein the insights from each peer group are shared on social media with a wider community.
